(19) United States
(12) Patent Application Publication
(10) Pub. No.: US 2015/0014553 A1
(43) Pub. Date: Jan. 15, 2015

(54) FILM WITH CODES, READER USED FOR READING THE FILM AND ELECTRONIC DEVICE WITH A DISPLAY DEVICE WITH THE FILM

(71) Applicant: NEOLAB CONVERGENCE INC., Seoul (KR)

(72) Inventors: Sang-Gyu LEE, Seoul (KR); Suk-Joo LEE, Yongin-si (KR); Bong-Ki PARK, Yongin-si (KR); A-Ram MOON, Anyang-si (KR)

(73) Assignee: NEOLAB CONVERGENCE INC., Seoul (KR)

(21) Appl. No.: 14/504,864

(22) Filed: Oct. 2, 2014

Related U.S. Application Data
(63) Continuation of application No. PCT/KR2013/001505, filed on Feb. 26, 2013.

(30) Foreign Application Priority Data
Apr. 3, 2012 (KR) 10-2012-0034292
May 2, 2012 (KR) 10-2012-0046139

(51) Int. Cl. G01N 21/64; G01N 21/84

(52) U.S. Cl. CPC G01N 21/64; G01N 21/84; G01N 2021/6497
USPC 250/461.1; 250/458.1; 250/566

(57) ABSTRACT

A film with codes, a reader configured to read the film, and an electronic device having a display including the film are provided. The reader may include a first light irradiating section, a second light irradiating section, a control section, and a light capturing section.

### CROSS-REFERENCE TO RELATED APPLICATIONS

This application is a Continuation application of PCT Application No. PCT/KR2013/001505, filed on Feb. 26, 2013, which claims priority to Korean Patent Application No. KR 10-2012-0034292 filed on Apr. 3, 2012, in the Korean Intellectual Property Office, and Korean Patent Application No. KR 10-2012-0046139 filed on May 2, 2012, in the Korean Intellectual Property Office, the entire disclosures of which are incorporated herein by reference for all purposes.

### BACKGROUND

1. Field

The following description relates to a film with codes, a reader used for reading the film, and an electronic device with a display device with the film. The codes may be formed on a transparent material surface that may be attached to a display section of the electronic device.

2. Description of Related Art

Typically, in a reader which reads codes formed on a surface of a reading target, light irradiated by a light irradiating section of the reader and light captured by a light capturing section of the reader have the same wavelength. Therefore, the light irradiated by the light irradiating section may be captured by the light capturing section unless a diffused reflection surface such as paper is used. As a result, the light irradiating section and the light capturing section must be optically separated.

Further, when light is irradiated onto a transparent film with codes by the light irradiating section, light spot may be generated by a regular reflection, and other portions cannot be captured which may cause a “mirror phenomenon”.

During a mirror phenomenon, the light spot takes effect based on the angle of the reading target. The light spot cannot be defined in the image captured by a sensor and it is much harder to readout codes.

Thus, there are typically less problems when using a surface of an opaque material such as a paper, on which codes are printed. However, problems in reading codes are typically encountered when codes are printed on a transparent surface attached to a display section of an electronic device displaying an image.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a reader includes a light irradiating section configured to irradiate a light of a first wavelength onto a film; and a light capturing section configured to capture only a light of a second wavelength.

The film may include codes formed by a fluorescent material; and the light of the second wavelength may be generated by the fluorescent material in response to the light of the first wavelength being irradiated onto the codes.

The film may be configured to be attached onto a surface of a display of an electronic device, and the film is transparent.

The light of the first wavelength may include ultraviolet light or infrared light, and the light of the second wavelength may include visible light.

The second wavelength may be outside a wavelength range of light used in the display device.

The light capturing section may include a filter configured to allow only the light of the second wavelength to pass therethrough.

In another general aspect, a reader includes a first light irradiating section configured to irradiate a light of a first wavelength onto a product with codes; a second light irradiating section configured to irradiate a light of a second wavelength onto the product with codes; a control section configured to control the first and second light irradiating sections; and a light capturing section configured to receive the light of the second wavelength.

The control section may be further configured to control the first and second light irradiating sections such that only one of the first and second light irradiating sections irradiates light; the light capturing section may capture the light of the second wavelength, generated by the codes, in response to the light of the first wavelength being irradiated onto the product and the codes generating the light of the second wavelength; and the light capturing section may capture the light of the second wavelength, reflected by regions other than the codes, in response to the light of the second wavelength being irradiated onto the product and the codes absorbing the light of the second wavelength.

The control section may be configured to control the second light irradiating section to irradiate the light of the second wavelength in response to the reader being operated, and may be configured to determine if brightness of an image of the product with codes, which is captured by the light capturing section, is equal to or higher than a reference brightness.

The control section may be configured to interpret codes, based on points having a relatively lower brightness, in response to the control section determining that the brightness of the image is equal to or greater than the reference brightness.

The control section may be configured to control the second light irradiating section to stop operation and the first light irradiating section to irradiate the light with the first wavelength in response to the control section determining that the brightness of the image is lower than the reference brightness.

The control section may be configured to interpret codes based on points having a relatively greater brightness in the image captured by the light capturing section from the product with codes.

The light of the first wavelength may include ultraviolet light, and the light of the second wavelength may include infrared light.

In another general aspect, a film includes a film layer; and an information layer comprising codes formed by a fluorescent material, wherein the fluorescent material generates light of a second wavelength in response to a reader irradiating light of a first wavelength.

The information layer may be on the film layer, and the light of the second wavelength may be capable of being captured by the reader.

The film may be configured to be attached to a surface of a display of an electronic device, and the film layer may be transparent.

The light of the first wavelength may include ultraviolet light or infrared light, and the light of the second wavelength may include visible light.

The second wavelength may be outside a wavelength range of light used in the display device.

In another general aspect, a film includes a film layer; a first fluorescent material configured to generate light of a second wavelength in response to a reader irradiating light of a first wavelength; and a second fluorescent material configured to absorb the light of the second wavelength and display codes.

The first fluorescent material may be on the first layer and the second fluorescent material may be on the first fluorescent material.

The light of the first wavelength may include ultraviolet light, and the light of the second wavelength may include infrared light.

The film may include a protection layer over the film layer, wherein the protection layer is configured to protect the codes displayed by the second fluorescent material.

In another general aspect, a film includes a film layer comprising a first fluorescent material generating light of a second wavelength in response to a reader irradiating light of a first wavelength; and a second fluorescent material, on the first fluorescent material, configured to absorb the light of the second wavelength and display codes.

The light of the first wavelength may include ultraviolet light and the light of the second wavelength may include infrared light.

The film may include a protection layer, over the film layer, configured to protect codes displayed by the second fluorescent material.

In another general aspect, an electronic device includes a display, a film comprising codes attached to the display, wherein the film comprises a film layer that is transparent and an information layer formed on the film layer, the information layer configured to display the codes with fluorescent material, and the fluorescent material generates light of a second wavelength, which is capable of being captured by a reader, in response to the reader irradiating light of a first wavelength.

The light of the first wavelength may include ultraviolet light and the light of the second wavelength may include infrared light.

The second wavelength may be outside a wavelength range of light used in the display device.

In another general aspect, an electronic device includes a display; a film attached to the display, wherein the film comprises a film layer comprising a first fluorescent material configured to generate light of a second wavelength in response to a reader irradiating light of a first wavelength; and a second fluorescent material, on the film layer, configured to absorb the light of the second wavelength.

The light of the first wavelength may include ultraviolet light and the light of the second wavelength may include infrared light.

In another general aspect, there is provided an electronic device including a display; a film attached to the display, wherein the film includes a film layer; a first fluorescent material, applied to the film layer, configured to generate light of a second wavelength in response to a reader irradiating light of a first wavelength; and a second fluorescent material, on the first fluorescent material, configured to absorb the light with the second wavelength and display codes.

The light with the first wavelength may include ultraviolet light and the light with the second wavelength may include infrared light.

### BRIEF DESCRIPTION OF THE DRAWINGS

FIG. 1 is a diagram illustrating an example of a reading operation of a reader.

FIG. 2 is a diagram illustrating an example of an image captured by a light capturing section of a reader.

FIG. 3 is a diagram illustrating an example of a structure of film with codes.

FIG. 4 is a diagram illustrating an example of a structure of a reader.

FIG. 5 is a diagram illustrating an example of a captured image of a printed surface.

FIG. 6 is a diagram illustrating an example of a reader.

FIG. 7 is a diagram illustrating an example of an operation of a reader.

FIG. 8 is a diagram illustrating an example of a structure of a film with codes.

FIG. 9 is a diagram illustrating an example of an image of a perforation film.

FIG. 10 is a diagram illustrating an example of a film with codes.

FIG. 11 is a diagram illustrating an example of a reading operation of a reader reading a film with codes according to an exemplary embodiment of the present invention.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

FIG. 1 is a diagram illustrating an example of a reading operation of a reader. Referring to FIG. 1, a reader 100 includes a light irradiating section 110 and a light capturing section 150. The reader 100 reads out code information from a film with codes 200.

The film with codes 200 includes a film layer 210 on which codes are formed by a fluorescent material 233. The film layer 210 may be transparent. When light with a first wavelength is irradiated by the light irradiating section 110 of the reader 100 onto the fluorescent material 233, the fluorescent material 233 generates light with a second wavelength, which can be captured by the light capturing section 150.

In another example, the light with a first wavelength may be ultraviolet light, and the light with a second wavelength may be infrared light. When the light irradiating section 110 irradiates ultraviolet light with a first wavelength onto the film with codes 200, the fluorescent material 233 on a position to generate codes generates the infrared light with a second wavelength.

That is, in this example, the fluorescent material 233 is fluorescent dye generating infrared light through ultraviolet light. For example, sodium chloride compounds or hydrate calcium sulfate compounds may be used as the fluorescent material 233.

In another example, the light with a first wavelength may be infrared light or ultraviolet light, and the light with a second wavelength may be visible light.

In this example, the fluorescent material 233 used for forming codes is fluorescent material generating visible light by receiving ultraviolet light or infrared light. For example, a quantum dot material with a core of europium oxynitride, cadmium selenide (CdSe), cadmium tellurium (CdTe), or cadmium sulfide (CdS), or an indium phosphide quantum dot material may be used.

When the light irradiating section 110 irradiates light with a first wavelength onto the film with codes 200, the fluorescent material 233 on a position on the film 210 to generate code information generates light with a second wavelength.

The light capturing section 150 of the reader 100 may only capture light of a second wavelength. Thus, the light capturing section 150 may have a band pass filter 153 allowing only light of a second wavelength to pass therethrough. The band pass filter 153 may be disposed at a front side of an image sensor 155.

The light capturing section 150 may include filters such a low pass filter, a high pass filter, a band pass filter, among other types of filters, as required to minimize error in code recognition of the reader 100 and noise that may be induced by a light source of the display device.

That is, only the light with a second wavelength generated by the fluorescent material 233 can pass through the band pass filter 153 of the light capturing section 150 such that the image sensor 155 can obtain an image. The image is generated when light of a second wavelength is received resulting from light of a first wavelength being irradiated onto the fluorescent material 233.

When the image is captured, a region of the fluorescent material 233 is displayed brightly and other regions are displayed darkly. Accordingly, a pattern information of dot code, bar code or line segment code that are formed by the fluorescent material 233 can be obtained.

For example, the film layer 210 of FIG. 1 is made of a material that absorbs the light of second wavelength and is irresponsive to the light of first wavelength, since regions where the fluorescent material is not formed is darkly displayed.

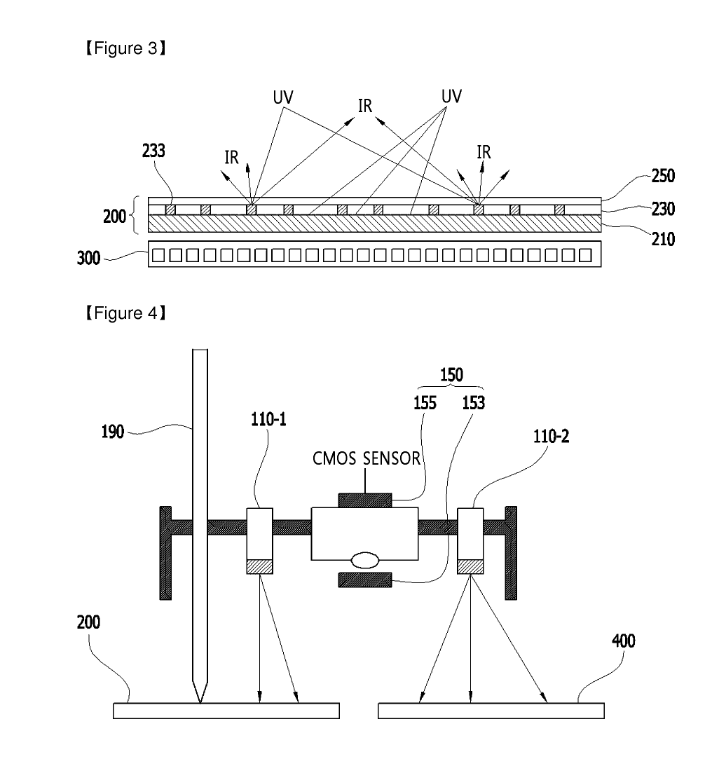

FIG. 3 is a diagram illustrating an example of a structure of film with codes. Referring to FIG. 3, the film with codes 200 includes a film layer 210, an information layer 230, and a protection layer 250.

The information layer 230 is a layer with code information which is formed on the film layer 210. The code information is formed by the fluorescent material 233 that generates light of a second wavelength when light of a first wavelength is irradiated by the light irradiating section 110 of the reader 100.

The fluorescent material 233 forming the information layer 230 is protected by the protection layer 250 formed on the information layer 230. For example, the protection layer 250 may be formed by Polyethylene Terephthalate (PET) material.

The film layer 210 is formed by a material that absorbs the light with a second wavelength, which is captured by the light capturing section 150. For example, the film with codes 200 may be formed of PET film that is transparent such that the film 200 can be applied to a display device 300.

In another example, when the film 200 is applied to the display device 300, it is preferable that the light captured by the light capturing section 150 of the reader 100 has a wavelength range outside the range of visible light in order to prevent the reader 100 from malfunctioning due to light received from the display device 300.

If the light of a second wavelength has a wavelength range of visible light, it is preferable that the light capturing section 150 of the reader 100 captures only visible light generated by the fluorescent material but not visible light generated by the display device 300 in order to prevent the reader 100 from malfunctioning due to visible light received from the display device 300.

Accordingly, the visible light generated by the fluorescent material may have a wavelength range outside the range of the visible light generated by the display device.

In general, a display device emits visible light of which range is lower than 700 nm. Further a display device does not emit 400 nm wavelength (blue light), 490 nm wavelength (light between blue and green light), and 590 nm wavelength (light between red and green light).

Therefore, in an example, the visible light generated by the fluorescent material has a wavelength of greater than 700 nm, 400 nm of blue light, 490 nm between blue and green light, or 590 nm between red and green light. Halo silicate-based phosphor, europium oxynitride based phosphor, gallium oxide based phosphor, vanadate based phosphor may be applied to the fluorescent material 233. Further, quantum dot material emitting light with the above ranged wavelength may be applied to the fluorescent material 233.

Further, fluorescent dye of the information layer 230 may have high transmittance with respect to visible light emitted by the display device 300 in order to reduce distortion of images displayed by the display device 300. Additionally, the size of dots in the code pattern may be reduced in order to lower the density of fluorescent material.

FIG. 4 is a diagram illustrating an example of a structure of a reader 100. The reader 100 of FIG. 4 includes a first light irradiating section 110-1 irradiating light of a first wavelength, and a second light irradiating section 110-2 irradiating light of a second wavelength in order to selectively irradiate light.

The light of a first wavelength may be ultraviolet light and the light of a second wavelength may be infrared light. In FIG. 4, the first light irradiating section 110-1 irradiating ultraviolet light enables the reader 100 to read out the film with codes 200 in FIG. 1 by irradiating ultraviolet light onto the film, and the second light irradiating section 110-2 irradiating infrared light enables the reader 100 to read out general printed surfaces such as a paper on which dot code is formed by using dye which absorbs infrared light.

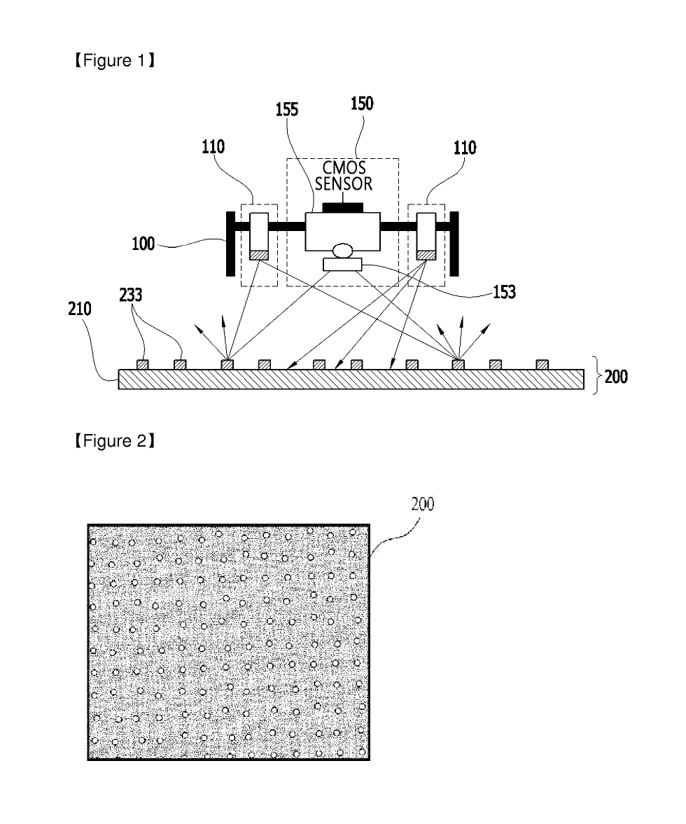

The operation of the first light irradiating section 110-1 is substantially the same as in FIG. 1 and FIG. 2. Therefore, only the operation of the second light irradiating section 110-2 will be explained.

When the second light irradiating section 110-2 irradiates infrared light onto a printed surface 400 on which dot code is formed by using dye that absorbs infrared light, the infrared light is absorbed at regions on which the dot code is formed and reflected at other regions. Accordingly, the region on which the dot code is formed is darkly displayed in an image captured by the light capturing section 150 that captures only infrared light as shown in FIG. 5.

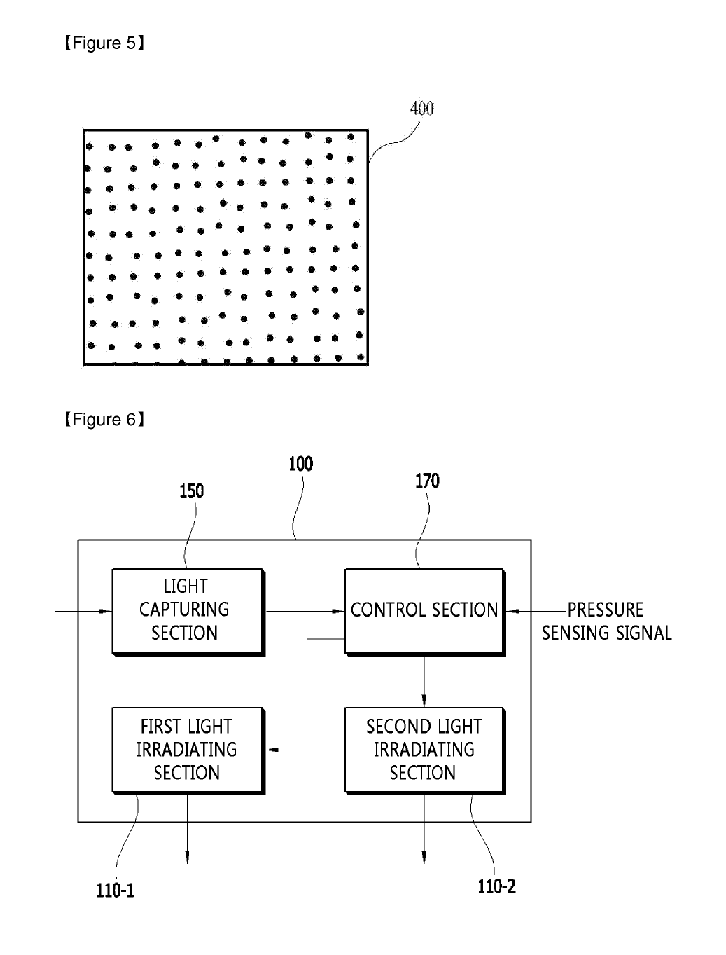

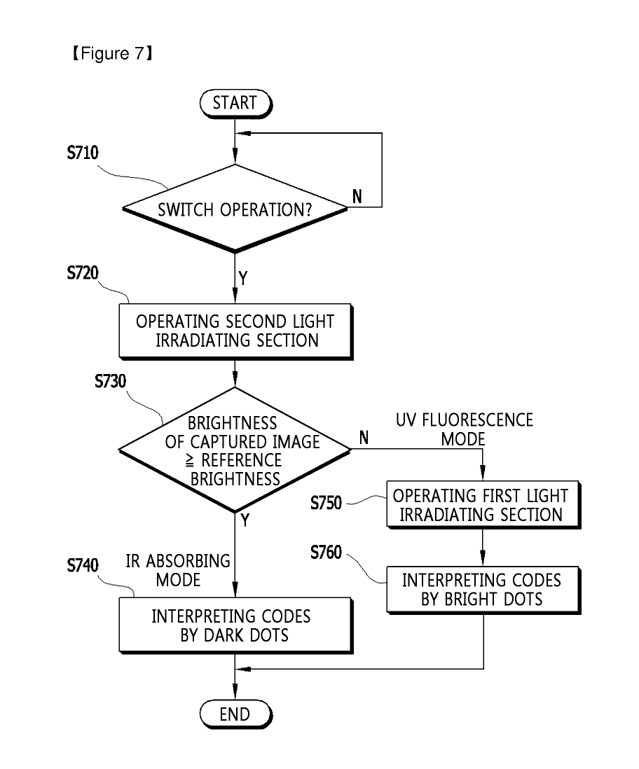

FIG. 6 is a diagram illustrating an example of a reader 100, and FIG. 7 is a diagram illustrating an example of an operation of a reader 100.

Referring to FIG. 4 through FIG. 7, a control section 170 of the reader 100 judges operation of a switch 190 (S710), and controls the second light irradiating section 110-2 to irradiate infrared light when the operation or the pressure of the switch 190 is detected (S270).

If the reading target is the film with codes 200 having fluorescent material 233, the image captured from the reading target by the light capturing section 150 is relatively dark since the film layer of the film with codes 200 absorbs infrared light. If the reading target is the printed surface 400 on which codes are formed by dye that absorbs infrared light, the image captured from the printed surface 400 by the light capturing section 150 is relatively bright since only regions on which codes are formed are displayed darkly and other regions are display brightly.

Therefore, the control section 170 judges if the brightness of the image obtained by the light capturing section 150 is equal to or greater than a reference brightness (S370). When the brightness of the image is equal to or greater than the reference brightness, the control section 170 determines that the image is captured from the printed surface 400 on which the dot code is formed by dye that absorbs infrared light as shown in FIG. 5. In this example, the reader interprets the codes based on the dark points.

When the brightness of the image obtained by the light capturing section 150 is less than the reference brightness, the control section 170 determines that the reading target is the film with codes 200 having codes formed by fluorescent material 233, and controls the second light irradiating section 110-2 to stop operating and the first light irradiating section 110-1 to irradiate ultraviolet light onto the reading target. In this example, the image captured by the light capturing section 150 is the image in which codes are displayed brightly due to the fluorescent material as shown in FIG. 2. The reader interprets the codes based on the bright point.

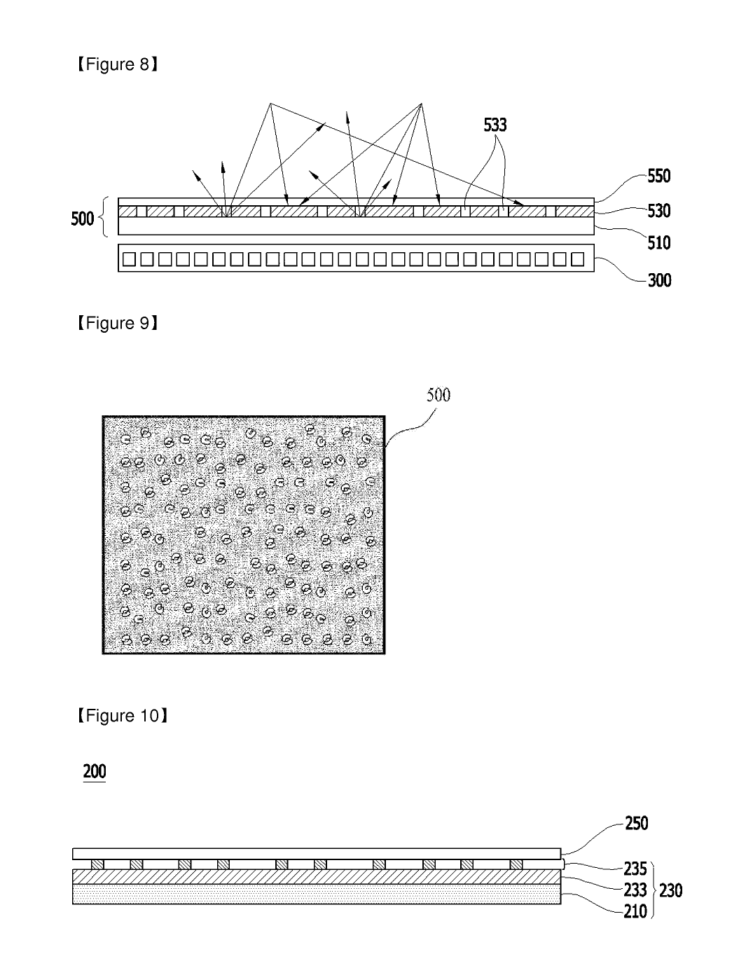

FIG. 8 is a diagram illustrating an example of a structure of a film with codes. Referring to FIG. 8, the film with codes includes a reflective layer 510, an information layer 530, and a protection layer 550.

The reflective layer 510 includes a material that reflects light irradiated by the light irradiating section 110 of the reader 100. The information layer 530 is disposed on the reflective layer 510, and absorbs the light irradiated by the light irradiating section 110 of the reader 100.

In the information layer 530, one or more perforation points 533 are formed in order to form dot codes, and the protection layer 550 is formed on the information layer 530 with the perforation points 533 to protect the perforation points 533. The film with codes may be referred to as a perforation film 500, since the film with codes displays codes through perforation points 533.

In this example, the perforation points 533 of the perforation film 500 may be formed by laser processing, press processing performed by protrusions, custom mold processing performed by a plurality of awl of code patterns.

The perforation film 500 has a multilayer structure as shown in FIG. 8. Therefore, when the light irradiating section 110 of the reader 100 irradiates infrared light onto the information layer 530, a portion of the infrared light arriving at regions with no perforation points are absorbed. Other portions of the infrared light arriving at perforation points 533 are not absorbed but reflected by the reflective layer 510 exposed through the perforation points 533.

As described above, portions of the infrared light reflected at the perforation points 533 are captured by the light capturing section 150 of the reader 100 so that the reader 100 obtains the image as shown in FIG. 9. The reader 100 interprets the codes pattern information based on the bright points.

The portions of infrared light passing through the perforation points 533 may be refracted to induce diffused reflection. Therefore, the direct capturing of light irradiated by the light irradiating section 110 through the light capturing section 150 and light spot resulting from a mirror phenomenon are prevented.

Further, the protection layer 550 and the reflective layer 510 may be formed of a transparent material so that the perforation film 500 may be applied to a display device 300.

When the perforation film 500 is applied to the display device 300 as shown in FIG. 8, the light irradiated by the light irradiating section 110, which is reflected by the reflective layer 510 and captured by the light capturing section 150 of the reader 100, may have a wavelength range outside of the range of visible light in order to prevent the malfunctioning of the reader which may be induced by light emitted from the display device 300.

FIG. 10 is a diagram illustrating an example of a film with codes. Referring to FIG. 10, the film with codes 200 includes a film layer 210, an information layer 230 and a protection layer 250.

The film layer 210 may be a transparent PET film such that the film with codes 200 may be applied to display device.

The information layer 230 is a layer with codes formed by a fluorescent material. The information layer 230 includes a first information layer 233 and a second information layer 235.

For example, a first fluorescent material in the first information layer 233 is a fluorescent material generating light of a second wavelength in response to receiving light of a first wavelength. The first fluorescent material may be coated on the film layer 210.

A second fluorescent material in the second information layer 235 is a material absorbing light of a second wavelength. The second fluorescent material is used for generating codes formed on the first information layer 233 which is on the film layer 210 as shown in FIG. 10.

In this example, the codes generated by the second fluorescent material may be one of a various types codes such as a dot code, a bar code, or a line segment code.

The fluorescent material forming the information layer 230 in FIG. 10 is protected by the protection layer 250, which is transparent and formed on the information layer 230. For example, the protection layer 250 may include PET material.

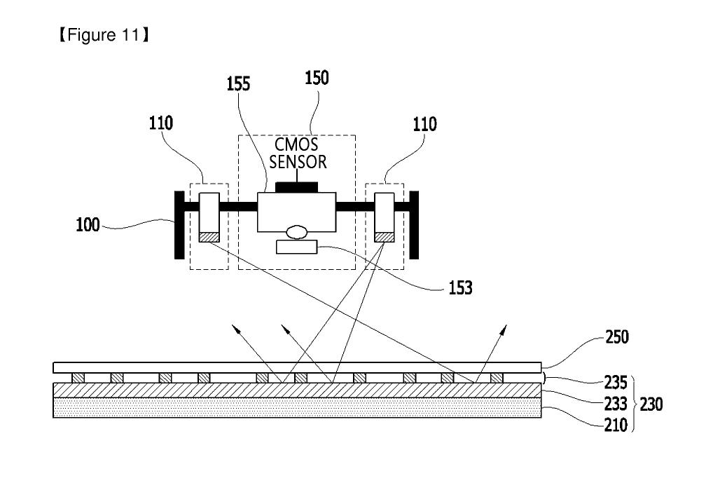

FIG. 11 is a diagram illustrating a reading operation of a reader reading a film with codes.

Referring to FIG. 11, the reader 100 includes a light irradiating section 110 and a light capturing section 150, and the reader 100 reads code information on the film with codes 200.

The light irradiating section 110 of the reader 100 irradiates light of a first wavelength. The first fluorescent material forming the first information layer 233 generates light of a second wavelength which is capable of being captured by the light capturing section 150 when the light of the first wavelength is irradiated.

In an example, the light of a first wavelength may be ultraviolet light, and the light of a second wavelength may be infrared light. In another example, the light of a first wavelength may be visible light, and the light of a second wavelength may be infrared light. In another example, the light of a first wavelength may be infrared light having a first wavelength and the light of a second wavelength may be infrared light having a second wavelength.

When the light irradiating section 110 of the reader 100 irradiates ultraviolet light of a first wavelength onto the film with codes 200, the first fluorescent material coating the film layer 210 generates infrared light.

When the infrared light generated by the first fluorescent material is captured by the light capturing section 150, the second fluorescent material on the film layer 210 absorbs the infrared light generated by the first fluorescent material, so that the image captured by the light capturing section 150 has dark regions expressing codes.

In this example, sodium chloride compounds or hydrated calcium sulfate compounds may be used for the first fluorescent material that receives ultraviolet light to generate infrared light.

The light capturing section 150 of the reader 100 captures only infrared light of a second wavelength. Accordingly, the light capturing section 150 may include a band pass filter 153 allowing only infrared light of a second wavelength to pass therethrough. The band pass filter 153 may be disposed at a front side of the image sensor 155.

For example, the band pass filter 153 allows only a portion of the light of a second wavelength, which is generated by the first fluorescent material except other portions absorbed by the second fluorescent material, to transmit therethrough. Accordingly, the image sensor 155 may obtain an image such as shown in FIG. 3.

When the film with codes 200 is applied to a display device, the light captured by the light capturing section 150 has wavelength outside the wavelength range of visible light in order to prevent malfunctioning of the reader 100 due to light emitted by the display device.

Further, fluorescent dye of the information layer 230 may be used because of its high transmittance of visible light emitted from the display device. This allows reduced distortion of the image displayed by the display device. Additionally, it is preferable to reduce the size of dots in the code pattern, which is formed by second fluorescent material, to lower density of the fluorescent material.

The first fluorescent material may be included in the film layer 210 as one unitary body rather than the first information layer 233 including the first fluorescent material being formed on the film layer 210.

For example, when a manufacturer manufactures the film layer 210, the manufacturer may mix the first fluorescent material 233 with the raw material of the film layer 210 for injection molding, so that the film layer 210 may function like the first information layer 233.

The various units, modules, elements, and methods described above may be implemented using one or more hardware components or a combination of one or more hardware components and one or more software components.

A hardware component may be, for example, a physical device that physically performs one or more operations, but is not limited thereto. Examples of hardware components include microphones, amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A reader comprising:
a light irradiating section configured to irradiate a light of a first wavelength onto a film; and
a light capturing section configured to capture only a light of a second wavelength.

2. The reader of claim 1, wherein
the film comprises codes formed by a fluorescent material; and
the light of the second wavelength is generated by the fluorescent material in response to the light of the first wavelength being irradiated onto the codes.

3. The reader of claim 1, wherein the film is configured to be attached onto a surface of a display of an electronic device, and the film is transparent.

4. The reader of claim 3, wherein the light of the first wavelength comprises ultraviolet light or infrared light, and the light of the second wavelength comprises visible light.

5. The reader of claim 4, wherein the second wavelength is outside a wavelength range of light used in the display device.

6. The reader of claim 5, wherein the light capturing section comprises a filter configured to allow only the light of the second wavelength to pass therethrough.

7. A reader comprising:
a first light irradiating section configured to irradiate a light of a first wavelength onto a product with codes;
a second light irradiating section configured to irradiate a light of a second wavelength onto the product with codes;
a control section configured to control the first and second light irradiating sections; and
a light capturing section configured to receive the light of the second wavelength.

8. The reader of claim 7, wherein
the control section is further configured to control the first and second light irradiating sections such that only one of the first and second light irradiating sections irradiates light;
the light capturing section is configured to capture the light of the second wavelength, generated by the codes, in response to the light of the first wavelength being irradiated onto the product and the codes generating the light of the second wavelength; and
the light capturing section is configured to capture the light of the second wavelength, reflected by regions other than the codes, in response to the light of the second wavelength being irradiated onto the product and the codes absorbing the light of the second wavelength.

9. The reader of claim 7, wherein the control section is configured to control the second light irradiating section to irradiate the light of the second wavelength in response to the reader being operated, and configured to determine if brightness of an image of the product with codes, which is captured by the light capturing section, is equal to or higher than a reference brightness.

10. The reader of claim 9, wherein the control section is configured to interpret codes, based on points having a relatively lower brightness, in response to the control section determining that the brightness of the image is equal to or greater than the reference brightness.

11. The reader of claim 9, wherein the control section is configured to control the second light irradiating section to stop operation and the first light irradiating section to irradiate the light with the first wavelength in response to the control section determining that the brightness of the image is lower than the reference brightness.

12. The reader of claim 9, wherein the control section is configured to interpret codes based on points having a relatively greater brightness in the image captured by the light capturing section from the product with codes.

13. The reader of claim 7, wherein the light of the first wavelength comprises ultraviolet light, and the light of the second wavelength comprises infrared light.

14. A film comprising:
a film layer; and
an information layer comprising codes formed by a fluorescent material,
wherein the fluorescent material generates light of a second wavelength in response to a reader irradiating light of a first wavelength.

15. The film of claim 14, wherein the information layer is on the film layer, and the light of the second wavelength is capable of being captured by the reader.

16. The film of claim 14, wherein the film is configured to be attached to a surface of a display of an electronic device, and the film layer is transparent.

17. The film of claim 16, wherein the light of the first wavelength comprises ultraviolet light or infrared light, and the light of the second wavelength comprises visible light.

18. The film of claim 17, wherein the second wavelength is outside a wavelength range of light used in the display device.

19. A film comprising:
a film layer;
a first fluorescent material configured to generate light of a second wavelength in response to a reader irradiating light of a first wavelength; and
a second fluorescent material configured to absorb the light of the second wavelength and display codes.

20. The film of claim 19, wherein the first fluorescent material is on the first layer and the second fluorescent material is on the first fluorescent material.

21. The film of claim 19, wherein the light of the first wavelength comprises ultraviolet light, and the light of the second wavelength comprises infrared light.

22. The film of claim 19, further comprising a protection layer over the film layer, wherein the protection layer is configured to protect the codes displayed by the second fluorescent material.

23. A film, comprising:
a film layer comprising a first fluorescent material generating light of a second wavelength in response to a reader irradiating light of a first wavelength; and
a second fluorescent material, on the first fluorescent material, configured to absorb the light of the second wavelength and display codes.

24. The film of claim 23, wherein the light of the first wavelength comprises ultraviolet light and the light of the second wavelength comprises infrared light.

25. The film of claim 23, further comprising a protection layer, over the film layer, configured to protect codes displayed by the second fluorescent material.

26. An electronic device, comprising:
a display; and
a film comprising codes attached to the display,
wherein the film comprises a film layer that is transparent and an information layer formed on the film layer, the information layer configured to display the codes with fluorescent material; and
the fluorescent material generates light of a second wavelength, which is capable of being captured by a reader, in response to the reader irradiating light of a first wavelength.

27. The electronic device of claim 26, wherein the light of the first wavelength comprises ultraviolet light and the light of the second wavelength comprises infrared light.

28. The electronic device of claim 26, wherein the second wavelength is outside a wavelength range of light used in the display device.

29. An electronic device, comprising:
a display;
a film attached to the display,
wherein the film comprises:
a film layer comprising a first fluorescent material configured to generate light of a second wavelength in response to a reader irradiating light of a first wavelength; and
a second fluorescent material, on the film layer, configured to absorb the light of the second wavelength.

30. The electronic device of claim 29, wherein the light of the first wavelength comprises ultraviolet light and the light of the second wavelength comprises infrared light.

31. An electronic device, comprising: a display;
a film attached to the display,
wherein the film comprises:
a film layer;
a first fluorescent material, applied to the film layer, configured to generate light of a second wavelength in response to a reader irradiating light of a first wavelength; and
a second fluorescent material, on the first fluorescent material, configured to absorb the light with the second wavelength and display codes.

32. The electronic device of claim 31, wherein the light with the first wavelength comprises ultraviolet light and the light with the second wavelength comprises infrared light.
